(19) United States
(12) Patent Application Publication
(10) Pub. No.: US 2025/0047424 A1
(43) Pub. Date: Feb. 6, 2025

(54) METHOD AND APPARATUS FOR HARQ-ACK FEEDBACK ON SIDELINK

(71) Applicant: Lenovo (Beijing) Limited, Beijing (CN)

(72) Inventors: Haipeng Lei, Beijing (CN); Xiaodong Yu, Beijing (CN); Zhennian Sun, Beijing (CN); Xin Guo, Beijing (CN)

(73) Assignee: Lenovo (Beijing) Limited, Beijing (CN)

(21) Appl. No.: 18/718,714

(22) PCT Filed: Dec. 20, 2021
(86) PCT No.: PCT/CN2021/139740

§ 371 Date: Jun. 11, 2024

(51) Int. Cl. H04L 1/1829; H04W 72/25

(52) U.S. Cl. CPC H04L 1/1864; H04L 1/1854; H04W 72/25

(57) ABSTRACT

Embodiments of the present disclosure relate to methods and apparatuses for HARQ-ACK feedback on a sidelink. According to some embodiments of the disclosure, a UE may receive a plurality of PSSCHs; determine whether a TB is transmitted repeatedly on the plurality of PSSCHs; and in response to determining the TB being transmitted repeatedly on the plurality of PSSCHs, generate a single HARQ-ACK information bit for the plurality of PSSCHs, and transmit a PSFCH carrying the single HARQ-ACK information bit according to a HARQ-ACK feedback option for the plurality of PSSCHs.

### TECHNICAL FIELD

Embodiments of the present disclosure generally relate to wireless communication technology, and more particularly to a hybrid automatic repeat request acknowledgement (HARQ-ACK) feedback transmission(s) on a sidelink.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In the above wireless communication systems, a user equipment (UE) may communicate with another UE via a data path supported by an operator's network, e.g., a cellular or a Wi-Fi network infrastructure. The data path supported by the operator's network may include a base station (BS) and multiple gateways.

Some wireless communication systems may support sidelink communications, in which devices (e.g., UEs) that are relatively close to each other may communicate with one another directly via a sidelink, rather than being linked through the BS. The term “sidelink” may refer to a direct radio link established for communicating among devices, as opposed to communicating via the cellular infrastructure (e.g., uplink and downlink). The term “sidelink” may also be referred to as a sidelink communication link.

The industry desires technologies for HARQ-ACK feedback transmission on a sidelink in a communication system.

### SUMMARY

Some embodiments of the present disclosure provide a user equipment (UE). The UE may include: a transceiver; and a processor coupled to the transceiver. The processor may be configured to: receive a plurality of physical sidelink shared channels (PSSCHs); determine whether a transport block (TB) is transmitted repeatedly on the plurality of PSSCHs; and in response to determining the TB being transmitted repeatedly on the plurality of PSSCHs, generate a single hybrid automatic repeat request acknowledgement (HARQ-ACK) information bit for the plurality of PSSCHs, and transmit a physical sidelink feedback channel (PSFCH) carrying the single HARQ-ACK information bit according to a HARQ-ACK feedback option for the plurality of PSSCHs.

Some embodiments of the present disclosure provide a user equipment (UE). The UE may include: a transceiver; and a processor coupled to the transceiver. The processor may be configured to: transmit a plurality of physical sidelink shared channels (PSSCHs); and in response to a transport block (TB) being transmitted repeatedly on the plurality of PSSCHs, receive a physical sidelink feedback channel (PSFCH) carrying a single hybrid automatic repeat request acknowledgement (HARQ-ACK) information bit for the plurality of PSSCHs according to a HARQ-ACK feedback option for the plurality of PSSCHs.

Some embodiments of the present disclosure provide a method for wireless communication performed by a user equipment (UE). The method may include: receiving a plurality of physical sidelink shared channels (PSSCHs); determining whether a transport block (TB) is transmitted repeatedly on the plurality of PSSCHs; and in response to determining the TB being transmitted repeatedly on the plurality of PSSCHs, generating a single hybrid automatic repeat request acknowledgement (HARQ-ACK) information bit for the plurality of PSSCHs, and transmitting a physical sidelink feedback channel (PSFCH) carrying the single HARQ-ACK information bit according to a HARQ-ACK feedback option for the plurality of PSSCHs.

Some embodiments of the present disclosure provide a method for wireless communication performed by a user equipment (UE). The method may include: transmitting a plurality of physical sidelink shared channels (PSSCHs); and in response to a transport block (TB) being transmitted repeatedly on the plurality of PSSCHs, receiving a physical sidelink feedback channel (PSFCH) carrying a single hybrid automatic repeat request acknowledgement (HARQ-ACK) information bit for the plurality of PSSCHs according to a HARQ-ACK feedback option for the plurality of PSSCHs.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a flow chart of an exemplary procedure of wireless communications in accordance with some embodiments of the present disclosure;

FIG. 3 illustrates a flow chart of an exemplary procedure of wireless communications in accordance with some embodiments of the present disclosure; and

FIG. 4 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

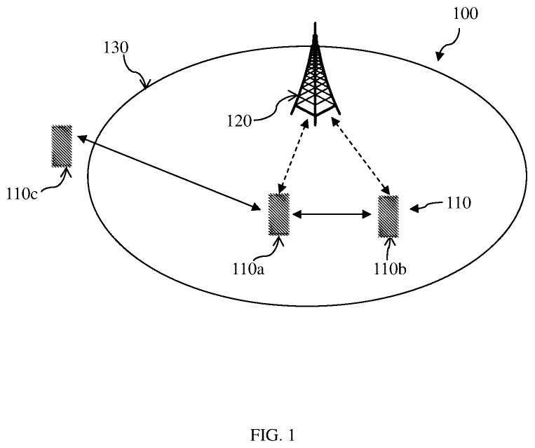

FIG. 1 illustrates a schematic diagram of a wireless communication system 100 in accordance with some embodiments of the present disclosure.

As shown in FIG. 1, a wireless communication system 100 may include a base station (e.g., BS 120) and some UEs 110 (e.g., UE 110a, UE 110b, and UE 110c). Although a specific number of UEs 110 and one BS 120 are depicted in FIG. 1, it is contemplated that any number of BSs and UEs in and outside of the coverage of the BSs may be included in the wireless communication system 100.

In some embodiments of the present disclosure, BS 120 may be referred to as an access point, an access terminal, a base, a base unit, a macro cell, a Node-B, an evolved Node B (eNB), a gNB, a Home Node-B, a relay node, or a device, or described using other terminology used in the art. BS 120 is generally a part of a radio access network that may include one or more controllers communicably coupled to one or more corresponding BSs. BS 120 may communicate with UE(s) 110 via downlink (DL) communication signals.

UE(s) 110 (e.g., UE 110a, UE 110b, or UE 110c) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, UE(s) 110 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, UE(s) 110 includes wearable devices, such as smart watches, fitness bands, optical head-mounted displays, or the like. Moreover, UE(s) 110 may be referred to as a subscriber unit, a mobile, a mobile station, a user, a terminal, a mobile terminal, a wireless terminal, a fixed terminal, a subscriber station, a user terminal, an IoT device, a vehicle, or a device, or described using other terminology used in the art. UE(s) 110 may communicate with BS 120 via uplink (UL) communication signals.

Wireless communication system 100 may be compatible with any type of network that is capable of sending and receiving wireless communication signals. For example, wireless communication system 100 is compatible with a wireless communication network, a cellular telephone network, a time division multiple access (TDMA)-based network, a code division multiple access (CDMA)-based network, an in orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, wireless communication system 100 is compatible with 5G NR of the 3GPP protocol. For example, BS 120 may transmit data using an orthogonal frequency division multiple (OFDM) modulation scheme on the DL and UE(s) 110 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS 120 and UE(s) 110 may communicate using other communication protocols, such as the IEEE 802.11 family of wireless communication protocols. Further, in some embodiments of the present disclosure, BS 120 and UE(s) 110 may communicate over licensed spectrums, whereas in some other embodiments, BS 120 and UE(s) 110 may communicate over unlicensed spectrums. The present disclosure is not intended to be limited to the implementation of any particular wireless communication system architecture or protocol.

BS 120 may define one or more cells, and each cell may have a coverage area 130. In the exemplary wireless communication system 100, some UEs (e.g., UE 110a and UE 110b) are within the coverage of BS 120, which may not be the specific BS 120 as shown in FIG. 1 and can be any one of the BSs 120 in a wireless communication system, and some UEs (e.g., UE 110c) are outside of the coverage of BS 120. For example, in the case that the wireless communication system includes two BSs 120 with UE 110a being within the coverage of any one of the two BSs means that UE 110a is within the coverage of a BS 120 (i.e., in-coverage) in the wireless communication system; and UE 110a being outside of the coverage of both BSs 120 means that UE 110a is outside the coverage of a BS 120 (i.e., out-of-coverage) in the wireless communication system.

Still referring to FIG. 1, UE 110a and UE 110b may communicate with BS 120 via, for example, a Uu link (denoted by dotted arrow in FIG. 1). UE 110a, UE 110b, and UE 110c may communicate with each other via a sidelink (denoted by solid arrow in FIG. 1).

Sidelink transmission may involve a physical sidelink control channel (PSCCH) and an associated physical sidelink shared channel (PSSCH), which is scheduled by the sidelink control information (SCI) carried on the PSCCH. The SCI and associated PSSCH may be transmitted from a transmitting UE (hereinafter referred to as “Tx UE”) to a receiving UE (hereinafter referred to as “Rx UE”) in a unicast manner, to a group of Rx UEs in a groupcast manner, or to Rx UEs within a range in a broadcast manner. For example, referring to FIG. 1, UE 110a (acting as a Tx UE) may transmit data to UE 110b or UE 110c (acting as an Rx UE).

The PSSCH may carry data which may require corresponding HARQ-ACK feedback from the Rx UE(s) to the Tx UE. In some examples, the broadcast transmission may not need HARQ-ACK feedback. In some examples, unicast and groupcast transmissions may enable HARQ-ACK feedback under certain preconditions. The HARQ-ACK feedback for a PSSCH may be carried on a physical sidelink feedback channel (PSFCH). In some embodiments of the present disclosure, one PSFCH can carry only a single HARQ-ACK information bit.

In some embodiments of the present disclosure, several HARQ-ACK feedback options including, but not limited to, the following two options may be applied for a HARQ-ACK feedback transmission corresponding to a PSSCH: (1) NACK-only based feedback, and (2) ACK/NACK based feedback. In the case of Option (1), an Rx UE may not transmit an ACK to the Tx UE when a PSSCH is successfully received (or decoded), and may transmit a NACK to the Tx UE when the PSSCH is not successfully received (or decoded). In the case of Option (2), the Rx UE may transmit an ACK to the Tx UE when a PSSCH is successfully received (or decoded), and may transmit a NACK to the BS when the PSSCH is not successfully received (or decoded).

In some embodiments of the present disclosure, in the case of a single carrier, when a plurality of PSFCH transmissions is to be transmitted by a UE in one slot, but the number of these PSFCH transmissions exceeds the maximum number (e.g., denoted as “N”) of PSFCH transmissions supported by the UE, the UE may transmit N PSFCHs with relatively higher priorities, subject to the UE capability and transmitting power.

In some embodiments of the present disclosure, for the purpose of reliability improvement of a sidelink transmission, a transport block (TB) may be repeatedly transmitted on a plurality of carriers (e.g., carried by corresponding PSSCHs on the plurality of carriers) or a plurality of PSSCHs (e.g., on at least one carrier). Accordingly, a UE may need to transmit a plurality of PSFCHs on, for example, a specific carrier (e.g., primary cell (PCell)) with each of the plurality of PSFCHs corresponding to a corresponding carrier or PSSCH, in addition to other PSFCHs for other TBs.

As mentioned above, in some embodiments of the present disclosure, the UE may have to select N PSFCHs from the plurality of PSFCHs based on their priorities and Tx power, as well as UE capability. In this scenario, some of the plurality of PSFCHs with relatively lower priorities may be dropped; and some PSFCHs corresponding to the same TB may be transmitted, although a single PSFCH for the same TB would be enough. Another drawback is that the PSFCHs corresponding to the same TB (if transmitted) would require an unnecessary Tx power increase. Assuming that M PSFCHs is transmitted for the same TB, it is obvious that the required Tx power for transmitting the M PSFCHs is M times the required Tx power for transmitting a single PSFCH. Therefore, unnecessary power is consumed. Yet another drawback is that the multiple PSFCHs for the same TB may be transmitted on a single physical resource block (PRB) with different cyclic shifts for distinguishing different PSFCHs. As a result, the error detection rate is increased when transmitting these PSFCHs on a single PRB compared with transmitting a single PSFCH on the single PRB.

Embodiments of the present disclosure provide solutions for HARQ-ACK feedback transmission when TB repetition for reliability improvement is supported. For example, methods for transmitting a single PSFCH for a TB (e.g., when the TB is repeatedly transmitted on a plurality of PSSCHs carried by a plurality of carriers or a single carrier) are proposed. The disclosed solutions can avoid the aforementioned drawbacks. More details on the embodiments of the present disclosure will be illustrated in the following text in combination with the appended drawings.

In some embodiments of the present disclosure, for sidelink transmission, a plurality of SCI formats may schedule a plurality of PSSCHs on at least one carrier. For example, each of the plurality of SCI formats may schedule one corresponding PSSCH of the plurality of PSSCHs on one corresponding carrier of a plurality of carriers. For example, each of the plurality of SCI formats may schedule one corresponding PSSCH of the plurality of PSSCHs on the same carrier.

In some embodiments, the concept of a PSSCH group is introduced. A PSSCH group may include one or more PSSCHs. The same TB may be carried by the PSSCH(s) in the same PSSCH group. A PSSCH group indicator (GI) may be included in a SCI format (that can be the 1st-stage SCI or 2nd-stage SCI, the definition of which is defined in 3GPP specifications) to indicate the group index of a PSSCH scheduled by the SCI format.

In the context of the present disclosure, the scheduled carrier refers to the carrier carrying the PSSCH scheduled by a SCI format, and the scheduled TB refers to the TB carried by the scheduled PSSCH or carrier. In other words, a SCI format may be associated with a scheduled PSSCH, a scheduled TB, and a scheduled carrier.

The number of bits to indicate the GI may be dependent on the maximum number of PSSCH groups. In some examples, a codepoint of the GI can be used to indicate that the scheduled TB is transmitted only on the scheduled PSSCH without repetition on other PSSCHs. In some examples, a plurality of SCI formats may indicate such codepoint of the GI for scheduling a plurality of PSSCHs carrying a plurality of different TBs without TB repetition on other PSSCHs. In these examples, assuming that a maximum of K PSSCH groups can be supported, a SCI format may include at least ┌log₂(K+1)┐ bits to indicate the GI, where each of the maximum of K PSSCH groups can be associated with a corresponding codepoint of the GI and the remaining codepoint of the GI can indicate that the scheduled TB is transmitted only on the scheduled PSSCH without repetition on other PSSCHs.

In the case of scheduling a plurality of PSSCHs on a plurality of carriers, indicating that the scheduled TB is repeated on the plurality of PSSCHs can be interpreted as indicating that the scheduled TB is repeated on the plurality of carriers, and indicating that the scheduled TB is transmitted only on the scheduled PSSCH without repetition on other PSSCHs of the plurality of carriers can be interpreted as indicating that the scheduled TB is transmitted only on the scheduled carrier without repetition on other carriers of the plurality of carriers.

For example, assuming that a maximum of three PSSCH groups is supported, then two bits (corresponding to four codepoints) are needed to indicate the GI. For instance, three codepoints can indicate three PSSCH groups and the remaining codepoint can indicate that the scheduled TB is transmitted only on the scheduled PSSCH without repetition on other PSSCHs. For example, “00” may indicate PSSCH group #0, “01” may indicate PSSCH group #1, “10” may indicate PSSCH group #2, and “11” may indicate that the scheduled TB is only transmitted on the scheduled PSSCH.

In some examples, ┌log₂ K)┐ bits may be needed to indicate the GI so that each of the maximum of K PSSCH groups can have an associated codepoint. In some examples, the SCI format may further include a TB repetition indicator to indicate whether the scheduled TB is repeated or not on other PSSCHs in addition to the scheduled PSSCH. The TB repetition indicator may include at least one bit.

For example, assuming that a maximum of two PSSCH groups is supported, then one bit (corresponding to two codepoints) is needed to indicate the GI. For instance, the two codepoints can indicate two PSSCH groups, respectively. For example, “0” may indicate PSSCH group #0, and “1” may indicate PSSCH group #1. In some examples, the SCI format may include an additional bit for the TB repetition indicator. For instance, “1” may indicate that the scheduled TB is repeated on the PSSCHs scheduled by SCI formats with the same GI as the SCI format scheduling the current scheduled PSSCH. “0” may indicate that the scheduled TB is transmitted only on the current scheduled PSSCH without repetition on other PSSCHs, regardless of the GI fields. In other words, in the latter case, the GI fields of the SCI formats can be neglected.

For a plurality of PSSCHs within the same PSSCH group, when these PSSCHs carry the same TB, a UE may only generate a single HARQ-ACK information bit (e.g., ACK or NACK) for the plurality of PSSCHs. That is, the UE may not generate a corresponding HARQ-ACK information bit for each of the plurality of PSSCHs. For example, when at least one PSSCH within a PSSCH group is correctly received or decoded, the UE may generate an ACK for the plurality of PSSCHs in the PSSCH group. When all of the PSSCHs within the PSSCH group are not correctly received or decoded, the UE may generate a NACK for the plurality of PSSCHs. In this way, for a PSSCH group, a single PSFCH indicating an ACK or NACK may be transmitted in the case of ACK/NACK based feedback, or a single PSFCH indicating a NACK may be transmitted in the case of NACK-only based feedback.

Otherwise, when a TB is scheduled only on one PSSCH (e.g., PSSCHs in the same PSSCH group schedules different TBs), a single HARQ-ACK information bit may be generated for the scheduled TB; and a single PSFCH indicating an ACK or NACK may be transmitted in the case of ACK/NACK based feedback, or a single PSFCH indicating a NACK may be transmitted in the case of NACK-only based feedback.

From the perspective of the Tx UE, it can flexibly adjust its transmission policy, for example, as follows: repeatedly transmitting a single TB on a plurality of carriers and setting the same GI for the SCI formats scheduling a plurality of PSSCHs on the plurality of carriers; repeatedly transmitting a single TB on a plurality of PSSCHs on the same carrier and setting the same GI for the SCI formats scheduling the plurality of PSSCHs; transmitting different TBs on a plurality of PSSCHs on a plurality of carriers and setting the GI fields or the TB repetition indicators of the SCI formats scheduling the plurality of PSSCHs to indicate that the corresponding scheduled TB is transmitted only on the scheduled carrier or PSSCH without repetition on other carriers or PSSCHs; or transmitting different TBs on a plurality of PSSCHs on the same carrier and setting the GI fields or the TB repetition indicators of the SCI formats scheduling the plurality of PSSCHs to indicate that the corresponding scheduled TB is transmitted only on the scheduled PSSCH without repetition on other PSSCHs.

From the perspective of the Rx UE, in response to the reception of a plurality of PSSCHs on a plurality of carriers (or a single carrier) scheduled by a plurality of SCI formats (which can be the 1st-stage SCI or 2nd-stage SCI), the Rx UE may check the GI field, the TB repetition field, or both to determine whether a single TB is repeatedly transmitted within a PSSCH group or a plurality of TBs is transmitted on the plurality of scheduled PSSCHs.

In the case of TB repetition within the PSSCH group, the Rx UE may generate, for example, a one-bit ACK for the TB when at least one PSSCH within the PSSCH group is correctly received or decoded. Otherwise, the Rx UE may generate a NACK when all PSSCHs within the PSSCH group are incorrectly received or decoded. In the case of ACK/NACK based feedback, the Rx UE may transmit a single PSFCH indicating an ACK or NACK. In the case of NACK-only based feedback, the Rx UE may transmit a single PSFCH indicating a NACK when a NACK is generated.

In the case of a TB scheduled only on one PSSCH, the Rx UE may generate, for example, a single HARQ-ACK information bit for the TB. In the case of ACK/NACK based feedback, the Rx UE may transmit a single PSFCH carrying the HARQ-ACK information bit (e.g., ACK or NACK). In the case of NACK-only based feedback, the Rx UE may transmit a single PSFCH indicating a NACK (e.g., when a NACK is generated for the TB).

In some embodiments of the present disclosure, for sidelink transmission, a plurality of SCI formats may schedule a plurality of PSSCHs on a plurality of carriers. Each of the plurality of SCI formats may schedule one corresponding PSSCH on a corresponding carrier.

In some embodiments, the concept of a carrier group is introduced. A carrier group may include one or more carriers. The same TB may be carried by the corresponding PSSCH(s) on the carrier(s) in the same carrier group. In some examples, radio resource control (RRC) signaling may be used to configure one or more carrier groups and which carriers belong to the same carrier group. In the context of the present disclosure, a PSSCH within a carrier group refers to a PSSCH transmitted on a carrier within the carrier group.

In some examples, a SCI format (which can be the 1st-stage SCI or 2nd-stage SCI) may include a repetition indicator to indicate whether the scheduled TB is repeated or not on other carriers within the same carrier group as the current scheduled carrier. The repetition indicator may include at least one bit. To keep consistency, the repetition indicators of the SCI formats on a plurality of carriers within the same carrier group is supposed to have the same value. A UE does not expect that the repetition indicators of the SCI formats on a plurality of carriers within the same carrier group to have different values.

For example, when a TB is repeated on a plurality of carriers within the same carrier group, each SCI format for scheduling a PSSCH on a corresponding one of the plurality of carriers may indicate that the scheduled TB is repeated on the carriers within the same carrier group as the current scheduled carrier (hereinafter referred as “enabling the repetition indicator of the SCI format”). Otherwise, when a TB is only transmitted on a single carrier, that is, without repetition on other carriers, in the case that TBs are transmitted on a plurality of carriers within the same carrier group, each SCI format for scheduling a PSSCH on a corresponding one of the plurality of carriers should indicate that the scheduled PSSCH on the scheduled carrier carries a TB without repetition on other carriers (hereinafter referred as “disabling the repetition indicator of the SCI format”).

For instance, assuming that the repetition indicator includes one bit, the repetition indicator being “1” (or “0”) may indicate that a single TB is repeated on a plurality of carriers within the same carrier group, e.g., all of the scheduled PSSCHs on the scheduled carriers within the same carrier group carry the same TB for the purpose of reliability improvement. The repetition indicator being “0” (or “1”) may indicate that a plurality of TBs is transmitted on the plurality of scheduled carriers within the same carrier group, e.g., each of the plurality of scheduled PSSCHs carries a corresponding TB for the purpose of increasing the data rate.

In the case of single TB repetition within a carrier group, a UE may only generate a single HARQ-ACK information bit for the plurality of scheduled PSSCHs carrying the TB. That is, the UE may not generate a corresponding HARQ-ACK information bit for each of the plurality of PSSCHs. For example, when at least one PSSCH of a plurality of PSSCHs scheduled on the carriers within the same carrier group is correctly received or decoded, the UE may generate an ACK for the plurality of PSSCHs within the carrier group. When all of the PSSCHs within the carrier group are not correctly received or decoded, the UE may generate a NACK for the plurality of PSSCHs. In this way, for a carrier group, a single PSFCH indicating an ACK or NACK may be transmitted in the case of ACK/NACK based feedback, or a single PSFCH indicating a NACK may be transmitted in the case of NACK-only based feedback.

Otherwise, when a TB is scheduled only on one carrier (e.g., carriers in the same carrier group schedules different TBs), a single HARQ-ACK information bit may be generated for the scheduled TB; and a single PSFCH indicating an ACK or NACK may be transmitted in the case of ACK/NACK based feedback, or a single PSFCH indicating a NACK may be transmitted in the case of NACK-only based feedback. For example, the UE may generate respective HARQ-ACK information bits for the plurality of TBs carried by the PSSCHs scheduled on the carriers within the same carrier group.

From the perspective of the Tx UE, it can flexibly adjust its transmission policy, for example, as follows: repeatedly transmitting a single TB on a plurality of carriers within the same carrier group and enabling the repetition indicators of the SCI formats scheduling a plurality of PSSCHs on the plurality of carriers; or transmitting different TBs on a plurality of carriers within the same carrier group and disabling the repetition indicators of the SCI formats scheduling a plurality of PSSCHs on the plurality of carriers, to indicate that the scheduled TB is transmitted only on the scheduled carrier without repetition on other carriers.

From the perspective of the Rx UE, in response to the reception of a plurality of PSSCHs on a plurality of carriers within a carrier group scheduled by a plurality of SCI formats (which can be 1st-stage SCI or 2nd-stage SCI), the Rx UE may check the repetition indicator to determine whether a single TB is repeated within the carrier group or a plurality of TBs is transmitted on the plurality of scheduled carriers within the carrier group.

In the case of TB repetition within the carrier group, the Rx UE may generate, for example, a one-bit ACK for the TB when at least one PSSCH within the carrier group is correctly received or decoded. Otherwise, the Rx UE may generate, for example, a NACK when all PSSCHs within the carrier group are incorrectly received or decoded. In the case of ACK/NACK based feedback, the Rx UE may transmit a single PSFCH indicating an ACK or NACK. In the case of NACK-only based feedback, the Rx UE may transmit a single PSFCH indicating a NACK if a NACK is generated.

In the case of a TB scheduled only on one carrier, the Rx UE may generate, for example, a single HARQ-ACK information bit for the TB. In the case of ACK/NACK based feedback, the Rx UE may transmit a single PSFCH indicating an ACK or NACK. In the case of NACK-only based feedback, the Rx UE may transmit a single PSFCH indicating a NACK (e.g., when a NACK is generated for the TB).

In some embodiments of the present disclosure, for sidelink transmission, a single SCI format (which can be the 1st-stage SCI, the 2nd-stage SCI or both) can schedule a plurality of PSSCHs on a plurality of carriers. The SCI format may include an indicator to indicate whether a single TB is repeated on the plurality of scheduled PSSCHs or carriers (hereinafter, “single TB repetition scheduling”) or a plurality of TBs is transmitted on the plurality of scheduled PSSCHs or carriers with each of the scheduled PSSCH or carrier carrying a respective TB (hereinafter, “multiple TB joint scheduling”).

The indicator may include at least one bit. For instance, assuming that the indicator includes one bit, the indicator being “1” (or “0”) may indicate a single TB repetition scheduling. In other words, a single TB is repeated on the plurality of scheduled PSSCHs (or carriers). For example, all of the scheduled PSSCHs may carry the same TB for the purpose of reliability improvement. The indicator being “O” (or “1”) may indicate a multiple TB joint scheduling. In other words, a plurality of TBs is transmitted on the plurality of scheduled PSSCHs (or carriers). For example, each of the plurality of scheduled PSSCHs may carry a respective TB for the purpose of increasing the data rate.

In the case of single TB repetition, a UE may only generate a single HARQ-ACK information bit for the plurality of scheduled PSSCHs carrying the TB. That is, the UE may not generate a corresponding HARQ-ACK information bit for each of the plurality of PSSCHs. For example, when at least one PSSCH of the plurality of scheduled PSSCHs is correctly received or decoded, the UE may generate an ACK for the plurality of PSSCHs. When all of the plurality of scheduled PSSCHs are not correctly received or decoded, the UE may generate a NACK for the plurality of PSSCHs. In this way, a single PSFCH indicating an ACK or NACK may be transmitted in the case of ACK/NACK based feedback, or a single PSFCH indicating a NACK may be transmitted in the case of NACK-only based feedback.

Otherwise, for multiple TB joint scheduling, a plurality of HARQ-ACK information bits may be generated for the plurality of scheduled PSSCHs carrying the plurality of transmitted TBs. In this case, a plurality of PSFCHs indicating an ACK or NACK may be transmitted in the case of ACK/NACK based feedback or a plurality of PSFCHs indicating a NACK may be transmitted in the case of NACK-only based feedback.

From the perspective of the Tx UE, it can flexibly adjust its transmission policy by adopting single TB repetition scheduling or multiple TB joint scheduling for different purposes.

From the perspective of the Rx UE, in response to the reception of a plurality of PSSCHs on a plurality of carriers scheduled by a single SCI format (which can be a 1st-stage SCI, 2nd-stage SCI or both), the Rx UE may check the above-described indicator in the SCI format to determine whether a single TB is repeated or a plurality of TBs is transmitted on the plurality of scheduled PSSCHs (or carriers).

In the case of single TB repetition scheduling, the Rx UE may generate, for example, a one-bit ACK for the TB when at least one PSSCH of the plurality of scheduled PSSCHs is correctly received or decoded. Otherwise, the Rx UE may generate, for example, a NACK when all of the plurality of scheduled PSSCHs are incorrectly received or decoded. In the case of ACK/NACK based feedback, the Rx UE may transmit a single PSFCH indicating an ACK or NACK. In the case of NACK-only based feedback, the Rx UE may transmit a single PSFCH indicating a NACK if a NACK is generated.

In the case of multiple TB joint scheduling, the Rx UE may generate a plurality of HARQ-ACK information bits for the plurality of scheduled PSSCHs carrying the plurality of transmitted TBs according to the decoding results. The UE may transmit a plurality of PSFCHs indicating an ACK or NACK in the case of ACK/NACK based feedback or one or more PSFCHs indicating a NACK in the case of NACK-only based feedback.

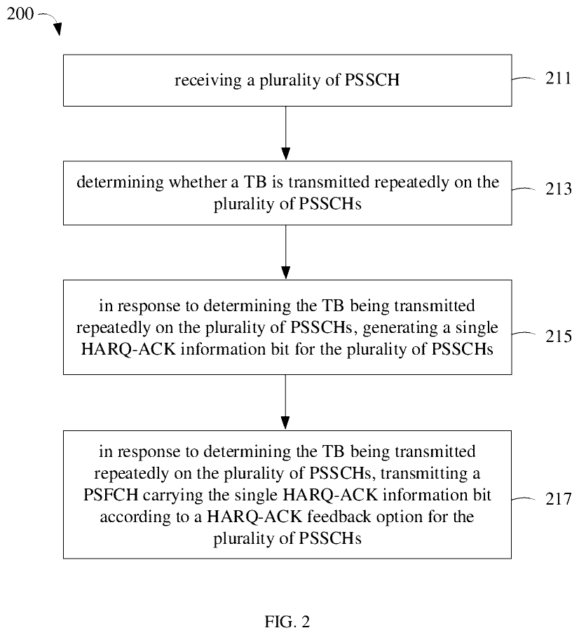

FIG. 2 illustrates a flow chart of an exemplary procedure 200 for wireless communications in accordance with some embodiments of the present disclosure. Details described in all of the foregoing embodiments of the present disclosure are applicable for the embodiments shown in FIG. 2. In some examples, the procedure may be performed by a UE, for example, UE 110 in FIG. 1.

Referring to FIG. 2, in operation 211, a UE may receive a plurality of PSSCHs. The PSSCHs may be transmitted on one or more carriers. In operation 213, the UE may determine whether a TB is transmitted repeatedly on the plurality of PSSCHs. For example, the UE may make such determination based on information indicated in the SCI format(s) scheduling the plurality of PSSCHs according to various methods as described above.

For example, in some embodiments of the present disclosure, each of the plurality of PSSCHs may be scheduled by a corresponding SCI format.

In some embodiments of the present disclosure, each of the SCI formats scheduling the plurality of PSSCHs may include a first indicator (e.g., the GI as described above) indicating a group index of a corresponding PSSCH group. The plurality of PSSCHs may be carried on one or more carriers. In some examples, each codepoint of the first indicator may indicate a corresponding group index. In some examples, a codepoint of the first indicator may indicate that the TB is not transmitted repeatedly on the plurality of PSSCHs. In some examples, each SCI format may further include a second indicator (e.g., the TB repetition indicator as described above) to indicate whether the TB is transmitted repeatedly on the plurality of PSSCHs.

In some embodiments of the present disclosure, the UE may determine that the plurality of PSSCHs is in the same group in response to the same group index being indicated in the SCI formats scheduling the plurality of PSSCHs. In some embodiments of the present disclosure, the UE may determine that the TB is transmitted repeatedly on the plurality of PSSCHs in response to the same group index being indicated in the SCI formats scheduling the plurality of PSSCHs. In some embodiments of the present disclosure, the UE may determine that different TBs are transmitted on the plurality of PSSCHs in response to different group indexes being indicated in the SCI formats scheduling the plurality of PSSCHs.

In some embodiments of the present disclosure, the plurality of PSSCHs may be received on a plurality of carriers. Each SCI format may include an indicator (e.g., the repetition indicator as described above) indicating whether the TB is transmitted repeatedly on the plurality of carriers. In some examples, the plurality of carriers may be configured as one carrier group by RRC signaling. In some examples, the UE may determine that the TB is transmitted repeatedly on the plurality of PSSCHs in response to the indicator indicating that the TB is transmitted repeatedly. In some examples, the UE may determine that different TBs are transmitted on the plurality of PSSCHs in response to the indicator indicating that the TB is not transmitted repeatedly.

In some embodiments of the present disclosure, the plurality of PSSCHs may be received on a plurality of carriers and may be scheduled by a single SCI format. The SCI format may include an indicator indicating whether the TB is transmitted repeatedly on the plurality of carriers. The UE may check the indicator in the SCI format to determine whether single TB repetition scheduling or multiple TB joint scheduling is employed.

In operation 215, in response to determining that the TB is transmitted repeatedly on the plurality of PSSCHs, the UE may generate a single HARQ-ACK information bit for the plurality of PSSCHs. For example, in response to at least one PSSCH of the plurality of PSSCHs being correctly decoded, the UE may generate an ACK for the plurality of PSSCHs. For example, in response to all of the plurality of PSSCHs being incorrectly decoded, the UE may generate a NACK for the plurality of PSSCHs.

In operation 217, in response to determining that the TB is transmitted repeatedly on the plurality of PSSCHs, the UE may transmit a PSFCH carrying the single HARQ-ACK information bit according to a HARQ-ACK feedback option for the plurality of PSSCHs. For example, in response to the HARQ-ACK feedback option indicating ACK/NACK based feedback, the UE may transmit a PSFCH indicating an ACK or a NACK (depending on the decoding results). For example, in response to the HARQ-ACK feedback option indicating NACK-only based feedback, and the HARQ-ACK information bit being a NACK, the UE may transmit a PSFCH indicating the NACK. That is, under the NACK-only based feedback, no PSFCH may be transmitted when one of the plurality of PSSCHs is correctly decoded, and thus operation 217 can be omitted.

In some embodiments of the present disclosure, in response to determining that the TB is not transmitted repeatedly on the plurality of PSSCHs, for each PSSCH of the plurality of PSSCHs, the UE may generate a HARQ-ACK information bit (e.g., an ACK or a NACK depending on the decoding result) for a corresponding PSSCH of the plurality of PSSCHs. For example, a plurality of HARQ-ACK information bits may be generated for the plurality of PSSCHs. For each PSSCH of the plurality of PSSCHs, the UE may transmit a PSFCH carrying the HARQ-ACK information bit according to the HARQ-ACK feedback option for the corresponding PSSCH.

For example, in response to the HARQ-ACK feedback option for a specific PSSCH of the plurality of PSSCHs indicating the ACK/NACK based feedback, the UE may transmit a PSFCH indicating an ACK or a NACK (depending on the decoding results) corresponding to the specific PSSCH. For example, in response to the HARQ-ACK feedback option indicating NACK-only based feedback, and the specific PSSCH being incorrectly decoded, the UE may transmit a PSFCH indicating a NACK corresponding to the specific PSSCH. That is, under the NACK-only based feedback, the UE may not transmit a PSFCH corresponding to the specific PSSCH when the specific PSSCH is correctly decoded.

It should be appreciated by persons skilled in the art that the sequence of the operations in exemplary procedure 200 may be changed and some of the operations in exemplary procedure 200 may be eliminated or modified, without departing from the spirit and scope of the disclosure.

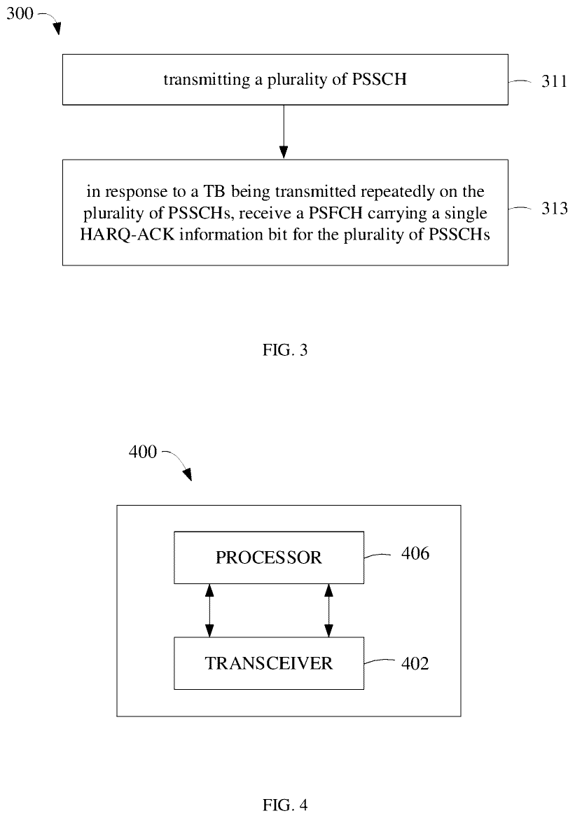

FIG. 3 illustrates a flow chart of an exemplary procedure 300 for wireless communications in accordance with some embodiments of the present disclosure. Details described in all of the foregoing embodiments of the present disclosure are applicable for the embodiments shown in FIG. 3. In some examples, the procedure may be performed by a UE, for example, UE 110 in FIG. 1.

Referring to FIG. 3, in operation 311, a UE may transmit a plurality of PSSCHs. The PSSCHs may be transmitted on one or more carriers.

For example, in some embodiments of the present disclosure, the UE may transmit a plurality of SCI formats to schedule the plurality of PSSCHs.

In some embodiments of the present disclosure, each of the plurality of SCI formats may include a first indicator (e.g., the GI as described above) indicating a group index of a corresponding PSSCH group. The plurality of PSSCHs may be carried on one or more carriers. In some examples, each codepoint of the first indicator may indicate a corresponding group index. In some examples, a codepoint of the first indicator may indicate that the TB is not transmitted repeatedly on the plurality of PSSCHs. In some examples, each of the plurality of SCI formats may further include a second indicator (e.g., the TB repetition indicator as described above) to indicate whether the TB is transmitted repeatedly on the plurality of PSSCHs.

In some embodiments of the present disclosure, the UE may set the first indicators of the plurality of SCI formats scheduling the plurality of PSSCHs to the same group index to indicate that the plurality of PSSCHs is in the same group. In some embodiments of the present disclosure, the UE may set the first indicators of the plurality of SCI formats scheduling the plurality of PSSCHs to the same group index to indicate the TB being transmitted repeatedly on the plurality of PSSCHs. In some embodiments of the present disclosure, the UE may set the first indicators of the plurality of SCI formats scheduling the plurality of PSSCHs to different group indexes to indicate different TBs being transmitted on the plurality of PSSCHs.

In some embodiments of the present disclosure, the plurality of PSSCHs may be transmitted on a plurality of carriers. Each of the plurality of SCI formats may indicate (e.g., the repetition indicator as described above) whether the TB is transmitted repeatedly on the plurality of carriers. In some examples, the plurality of carriers may be configured as one carrier group by RRC signaling. When the UE repeatedly transmits a single TB on the plurality of carriers within the same group, the UE may enable the indicators in the SCI formats. When the UE transmits different TBs on the plurality of carriers within the same group, the UE may disable the indicators in the SCI formats.

In some embodiments of the present disclosure, the UE may transmit a SCI format to schedule the plurality of PSSCHs on a plurality of carriers. The SCI format may indicate whether the TB is transmitted repeatedly on the plurality of carriers. When the UE repeatedly transmits a single TB on the plurality of carriers scheduled by the same SCI format, the SCI format may indicate a single TB repetition scheduling. When the UE transmits different TBs on the plurality of carriers scheduled by the same SCI format, the SCI format may indicate a multiple TB joint scheduling.

In operation 313, in response to a TB being transmitted repeatedly on the plurality of PSSCHs, the UE may receive a PSFCH carrying a single HARQ-ACK information bit for the plurality of PSSCHs according to a HARQ-ACK feedback option for the plurality of PSSCHs. For example, in response to the HARQ-ACK feedback option indicating ACK/NACK based feedback, the UE may receive a PSFCH indicating an ACK or a NACK (depending on the decoding results). For example, in response to the HARQ-ACK feedback option indicating NACK-only based feedback, and the HARQ-ACK information bit being a NACK, the UE may receive a PSFCH indicating the NACK. That is, under the NACK-only based feedback, the UE may not receive a PSFCH corresponding to the plurality of PSSCHs when the Rx UE correctly decodes one of the plurality of PSSCHs, and thus operation 313 can be omitted.

In some embodiments of the present disclosure, in response to the TB not being transmitted repeatedly on the plurality of PSSCHs, the UE may receive a PSFCH carrying a HARQ-ACK information bit for a corresponding PSSCH of the plurality of PSSCHs according to a HARQ-ACK feedback option for the corresponding PSSCH.

For example, in response to the HARQ-ACK feedback option for a specific PSSCH of the plurality of PSSCHs indicating the ACK/NACK based feedback, the UE may receive a PSFCH indicating an ACK or a NACK corresponding to the specific PSSCH. For example, in response to the HARQ-ACK feedback option indicating NACK-only based feedback, and the specific PSSCH being incorrectly decoded by the Rx UE, the UE may receive a PSFCH indicating a NACK corresponding to the specific PSSCH. That is, under the NACK-only based feedback, the UE may not receive a PSFCH corresponding to the specific PSSCH when the specific PSSCH is correctly decoded.

It should be appreciated by persons skilled in the art that the sequence of the operations in exemplary procedure 300 may be changed and some of the operations in exemplary procedure 300 may be eliminated or modified, without departing from the spirit and scope of the disclosure.

FIG. 4 illustrates a block diagram of an exemplary apparatus 400 according to some embodiments of the present disclosure. As shown in FIG. 4, the apparatus 400 may include at least one processor 406 and at least one transceiver 402 coupled to the processor 406. The apparatus 400 may be a UE.

Although in this figure, elements such as the at least one transceiver 402 and processor 406 are described in the singular, the plural is contemplated unless a limitation to the singular is explicitly stated. In some embodiments of the present application, the transceiver 402 may be divided into two devices, such as a receiving circuitry and a transmitting circuitry. In some embodiments of the present application, the apparatus 400 may further include an input device, a memory, and/or other components.

In some embodiments of the present application, the apparatus 400 may be a UE. The transceiver 402 and the processor 406 may interact with each other so as to perform the operations with respect to the UE described above, for example, in FIGS. 1-3.

In some embodiments of the present application, the apparatus 400 may further include at least one non-transitory computer-readable medium. For example, in some embodiments of the present disclosure, the non-transitory computer-readable medium may have stored thereon computer-executable instructions to cause the processor 406 to implement the method with respect to the UE as described above. For example, the computer-executable instructions, when executed, cause the processor 406 interacting with transceiver 402 to perform the operations with respect to the UE described in FIGS. 1-3.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including.” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE), comprising:
at least one memory; and
at least one processor coupled with the at least one memory and configured to cause the UE to:
receive a plurality of physical sidelink shared channels (PSSCHs);
determine whether a transport block (TB) is transmitted repeatedly on the plurality of PSSCHs; and
in response to determining the TB being transmitted repeatedly on the plurality of PSSCHs, generate a single hybrid automatic repeat request acknowledgement (HARQ-ACK) information bit for the plurality of PSSCHs, and transmit a physical sidelink feedback channel (PSFCH) carrying the single HARQ-ACK information bit according to a HARQ-ACK feedback option for the plurality of PSSCHs.

2. The UE of claim 1, wherein each of the plurality of PSSCHs is scheduled by a corresponding sidelink control information (SCI) format.

3. The UE of claim 2, wherein each of the SCI formats scheduling the plurality of PSSCHs includes a first indicator indicating a group index of a corresponding PSSCH group.

4. The UE of claim 3, wherein a codepoint of the first indicator indicates that the TB is not transmitted repeatedly on the plurality of PSSCHs.

5. The UE of claim 3, wherein the corresponding SCI format further includes a second indicator indicating whether the TB is transmitted repeatedly on the plurality of PSSCHs.

6. The UE of claim 3, wherein the at least one processor is further configured to cause the UE to:
determine the plurality of PSSCHs being in a same group in response to the group index being indicated in the SCI formats scheduling the plurality of PSSCHs;
determine the TB being transmitted repeatedly on the plurality of PSSCHs in response to the group index being indicated in the SCI formats scheduling the plurality of PSSCHs; or
determine different TBs being transmitted on the plurality of PSSCHs in response to different group indexes being indicated in the SCI formats scheduling the plurality of PSSCHs.

7. The UE of claim 2, wherein the plurality of PSSCHs is received on a plurality of carriers, and each SCI format includes an indicator indicating whether the TB is transmitted repeatedly on the plurality of carriers.

8. The UE of claim 7, wherein the plurality of carriers are configured as one carrier group by radio resource control (RRC) signaling.

9. The UE of claim 7, wherein the at least one processor is further configured to cause the UE to:
determine the TB being transmitted repeatedly on the plurality of PSSCHs in response to the indicator indicating that the TB is transmitted repeatedly; or
determine different TBs being transmitted on the plurality of PSSCHs in response to the indicator indicating that the TB is not transmitted repeatedly.

10. The UE of claim 1, wherein the plurality of PSSCHs are received on a plurality of carriers and scheduled by a single sidelink control information (SCI) format, and the SCI format includes an indicator indicating whether the TB is transmitted repeatedly on the plurality of carriers.

11. The UE of claim 1, wherein:
the HARQ-ACK information bit indicates an acknowledgement (ACK) in response to at least one PSSCH of the plurality of PSSCHs being correctly decoded; or
the HARQ-ACK information bit indicates a negative ACK (NACK) in response to all of the plurality of PSSCHs being incorrectly decoded.

12. The UE of claim 1, wherein the at least one processor is further configured to cause the UE, in response to determining the TB not being transmitted repeatedly on the plurality of PSSCHs, for each PSSCH of the plurality of PSSCHs:
generate a HARQ-ACK information bit for a corresponding PSSCH of the plurality of PSSCHs; and
transmit a PSFCH carrying the HARQ-ACK information bit according to a HARQ-ACK feedback option for the corresponding PSSCH.

13. The UE of claim 1, wherein, to transmit the PSFCH according to the HARQ-ACK feedback option, the at least one processor is configured to cause the UE to:
transmit the PSFCH indicating an acknowledgement (ACK) or a negative ACK (NACK) in response to the HARQ-ACK feedback option indicating ACK/NACK based feedback; or
transmit the PSFCH in response to the HARQ-ACK feedback option indicating NACK-only based feedback and the HARQ-ACK information bit being a NACK.

14. A user equipment (UE), comprising:
at least one memory; and
at least one processor coupled with the at least one memory and configured to cause the UE to:
transmit a plurality of physical sidelink shared channels (PSSCHs); and
in response to a transport block (TB) being transmitted repeatedly on the plurality of PSSCHs, receive a physical sidelink feedback channel (PSFCH) carrying a single hybrid automatic repeat request acknowledgement (HARQ-ACK) information bit for the plurality of PSSCHs according to a HARQ-ACK feedback option for the plurality of PSSCHs.

15. A method performed by a user equipment (UE), comprising:
receiving a plurality of physical sidelink shared channels (PSSCHs);
determining whether a transport block (TB) is transmitted repeatedly on the plurality of PSSCHs; and
in response to determining the TB being transmitted repeatedly on the plurality of PSSCHs, generating a single hybrid automatic repeat request acknowledgement (HARQ-ACK) information bit for the plurality of PSSCHs, and transmitting a physical sidelink feedback channel (PSFCH) carrying the single HARQ-ACK information bit according to a HARQ-ACK feedback option for the plurality of PSSCHs.

16. The method of claim 15, wherein each of the plurality of PSSCHs is scheduled by a corresponding sidelink control information (SCI) format.

17. The method of claim 16, wherein each of the SCI formats scheduling the plurality of PSSCHs includes a first indicator indicating a group index of a corresponding PSSCH group.

18. The method of claim 17, wherein a codepoint of the first indicator indicates that the TB is not transmitted repeatedly on the plurality of PSSCHs.

19. The method of claim 17, wherein the corresponding SCI format further includes a second indicator indicating whether the TB is transmitted repeatedly on the plurality of PSSCHs.

20. A processor for wireless communication, comprising:
at least one controller coupled with at least one memory and configured to cause the processor to:
receive a plurality of physical sidelink shared channels (PSSCHs);
determine whether a transport block (TB) is transmitted repeatedly on the plurality of PSSCHs; and
in response to determining the TB being transmitted repeatedly on the plurality of PSSCHs, generate a single hybrid automatic repeat request acknowledgement (HARQ-ACK) information bit for the plurality of PSSCHs, and transmit a physical sidelink feedback channel (PSFCH) carrying the single HARQ-ACK information bit according to a HARQ-ACK feedback option for the plurality of PSSCHs.
